(19) United States
(12) Patent Application Publication
(10) Pub. No.: US 2026/0364679 A1
(43) Pub. Date: Nov. 19, 2026

(54) SYSTEMS AND METHODS FOR DIAGNOSING LASER PERFORMANCE IN SELECTIVE LASER SINTERING DEVICES

(71) Applicant: FORMLABS, INC., Somerville, MA (US)

(72) Inventor: Michael Adnary, Cambridge, MA (US)

(73) Assignee: FORMLABS, INC., Somerville, MA (US)

(21) Appl. No.: 19/681,929

(22) Filed: May 19, 2026

Related U.S. Application Data
(60) Provisional application No. 63/807,995, filed on May 19, 2025.

(51) Int. Cl. B22F 10/28; B22F 12/90; B33Y 10/00; B33Y 50/02

(52) U.S. Cl. CPC B22F 10/28; B22F 12/90; B33Y 10/00; B33Y 50/02

(57) ABSTRACT

Methods and systems for diagnosing laser performance in a selective laser sintering (SLS) device. A performance reference is established by scanning a powder bed at two or more laser power settings, measuring corresponding heating rates with a temperature sensor, and determining a relationship between laser power and heating rate. To diagnose the device, a diagnostic scan is performed at a commanded power, a heating rate is measured, an inferred power is determined from the relationship, and the inferred power is compared to the commanded power; responsive to the deviation exceeding a threshold, a corrective action is applied, such as scaling a subsequent commanded power by a compensation factor. Optical-path integrity may further be evaluated by capturing an image of the powder bed during or after the diagnostic scan and analyzing the image to identify a region indicative of an optical-path condition.

### RELATED APPLICATIONS

The present application claims the benefit under 35 U.S.C. § 119(e) of U.S. Provisional Patent Application No. 63/807,995, filed May 19, 2025, titled “SYSTEMS AND METHODS FOR DIAGNOSING LASER PERFORMANCE IN SELECTIVE LASER SINTERING DEVICES,” which is hereby incorporated by reference in its entirety.

### FIELD OF INVENTION

This disclosure relates to selective laser sintering (SLS) systems, and more specifically, to methods and devices for diagnosing and monitoring laser performance during the sintering process.

### BACKGROUND

Additive manufacturing, also known as three-dimensional (3D) printing, encompasses a variety of technologies that build three-dimensional objects layer-by-layer from digital models. Among these technologies, selective laser sintering (SLS) is a widely used powder bed fusion process in which a laser selectively sinters polymer or other material powder to form a solid cross-section of the desired object.

In a typical SLS process, a thin layer of powder is spread across a build platform. A laser beam is directed, via scanning optics such as galvanometer mirrors, to selectively heat and sinter regions of the powder layer according to cross-sectional data derived from a 3D model. Once a layer is completed, the platform is lowered, and a new layer of powder is applied for subsequent sintering. This process repeats until the object is fully formed.

### SUMMARY

The present disclosure provides systems and methods for diagnosing, monitoring, and compensating for performance variations in a selective laser sintering (SLS) device, particularly with respect to laser output consistency, optical path integrity, and powder-bed response. In one aspect, a method is disclosed for establishing a performance reference by performing laser scans over at least a portion of a powder bed at different laser power settings, measuring corresponding heating rates of the powder bed using a temperature sensor, and determining a relationship between laser power and heating rate. The relationship may be used as a calibration or diagnostic reference for evaluating delivered laser energy under nominal or later-occurring operating conditions.

In another aspect, the system utilizes the reference relationship to assess laser performance during operation of the SLS device. A diagnostic laser scan is performed at a commanded laser power setting, a heating rate of the powder bed is measured, and an inferred laser power setting is determined based on the measured heating rate and the stored relationship between laser power and heating rate. The inferred laser power setting is compared with the commanded laser power setting to obtain a deviation, and, when the deviation exceeds a threshold, a corrective action may be applied. Such corrective action may include adjusting a subsequent commanded laser power setting using a compensation factor, generating an alert, inhibiting a build, scheduling maintenance, or otherwise modifying operation of the SLS device. In some embodiments, cooling-rate measurements, spatial heating-rate maps, upstream laser power monitor measurements, and trend analyses of time-series diagnostic data may be used to distinguish laser-source degradation, optical-path degradation, powder-bed condition anomalies, and progressive changes over time.

In a further aspect, an image-based diagnostic process is provided for evaluating an optical path of the SLS device. A diagnostic laser scan is performed over at least a portion of the powder bed, and an image of the powder bed is captured using a camera. The captured image is analyzed to identify visually distinct regions or spatially varying exposure patterns indicative of an optical-path condition, such as contamination, scratching, beam clipping, defocus, scanner misalignment, mirror contamination, reduced transmission, or nonuniform beam profile. In some embodiments, the scan pattern may originate at a central region of the powder bed and expand outward toward a peripheral region, the camera may image the powder bed coaxially with the laser beam, and images captured during the scan may be used to reconstruct a laser trajectory based on thermal or near-infrared emission from a locally heated region of the powder bed.

According to some aspects, these methods may enable an SLS device to self-monitor laser performance, powder-bed response, and optics health prior to or during printing. Thermal diagnostic information and image-based diagnostic information may be used separately or in combination to generate diagnostic results, apply spatial or power-based compensation, identify whether service or recalibration is warranted, and reduce the likelihood of failed builds while improving overall print reliability.

### BRIEF DESCRIPTION OF THE FIGURES

Various aspects and embodiments of the present invention will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic diagram of a selective laser sintering (SLS) printer, according to some embodiments.

FIG. 2 is a schematic diagram of an optical path for a laser beam traveling from a laser source, through a galvanometer scanner and an optics window, into a build chamber and onto a powder bed, according to some embodiments.

FIG. 3A is a graph illustrating a measured temperature profile and a corresponding heating-rate profile across a scanned region of a powder bed, according to some embodiments.

FIG. 3B is a graph illustrating a relationship between a measured heating rate and a predicted relative laser power, according to some embodiments.

FIGS. 4A-4B illustrate example images of a powder bed captured by a camera after a diagnostic laser scan, including localized visually distinct regions and spatially varying exposure patterns that may be indicative of optical-path defects, according to some embodiments.

FIG. 5 is a block diagram of a system suitable for practicing aspects of the disclosure, according to some embodiments.

FIG. 6 illustrates an example of a computing system environment on which aspects of the disclosure may be implemented.

### DETAILED DESCRIPTION

The accuracy and consistency of the laser beam are critical to the quality and reliability of SLS-printed parts. The laser must deliver a controlled and uniform energy output, and the optical path (including mirrors, lenses, and protective windows) must remain clean and unobstructed to ensure proper laser transmission and focus onto the powder bed. However, over time, lasers may experience performance degradation such as power drift, output instability, or beam profile changes. Similarly, contamination or defects in the optical path, such as dust accumulation or scratches on optical components, can lead to reduced or uneven laser intensity at the build surface.

Such issues may result in poor part quality, incomplete sintering, dimensional inaccuracies, or outright build failures. Further, these problems may go undetected prior to initiating a build, leading to wasted material, machine downtime, and increased costs.

Currently, many SLS systems lack integrated, reliable methods to verify laser output and optical cleanliness prior to a print job. Users may be unaware of laser power drift or optical contamination until defects appear in printed parts or builds fail entirely. Therefore, there remains a need for improved systems and methods for evaluating laser performance and optical path integrity in selective laser sintering systems.

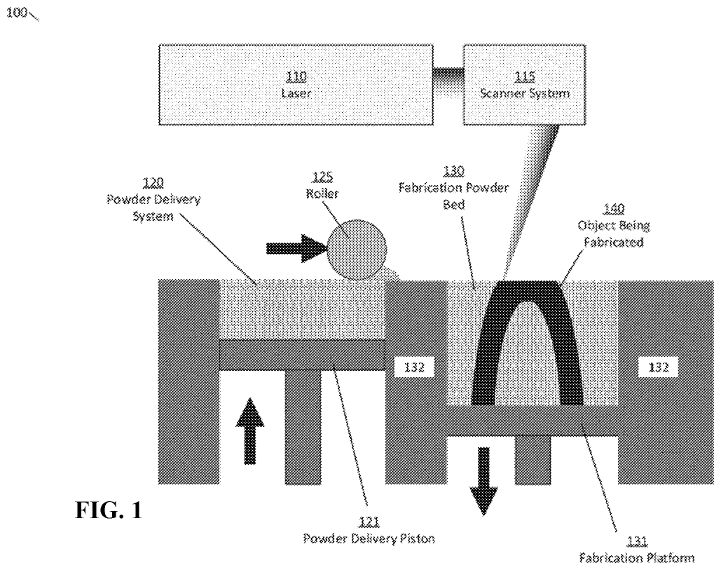

An illustrative selective laser sintering (SLS) additive fabrication device is illustrated in FIG. 1. In the example of FIG. 1, SLS device 100 comprises a laser 110 paired with a computer-controlled scanner system 115 disposed to operatively aim the laser 110 at the fabrication bed 130 and move over the area corresponding to a given cross-sectional area of a computer aided design (CAD) model representing a desired part. Suitable scanning systems may include one or more mechanical gantries, linear scanning devices using polygonal mirrors, and/or galvanometer-based scanning devices.

In the example of FIG. 1, the material in the fabrication bed 130 is selectively heated by the laser in a manner that causes the powder material particles to fuse (sometimes also referred to as “sintering” or “consolidating”) such that a new layer of the object 140 is formed. SLS is suitable for use with many different powdered materials, including any of various forms of powdered nylon. In some cases, areas around the fabrication bed (e.g., the walls 132, the platform 131, etc.) may include heating elements to heat the powder in the fabrication bed. Such heaters may be used to prebeat unconsolidated material, as discussed above, prior to consolidation via the laser.

Once a layer has been successfully formed, the fabrication platform 131 may be lowered a predetermined distance by a motion system (not pictured in FIG. 1). Once the fabrication platform 131 has been lowered, the material deposition mechanism 125 may be moved across the fabrication bed 130, spreading a fresh layer of material across the fabrication bed 130 to be consolidated as described above. Mechanisms configured to apply a consistent layer of material onto the fabrication bed may include the use of wipers, rollers, blades, and/or other levelling mechanisms for moving material from a source of fresh material to a target location.

Since material in the powder bed 130 is typically only consolidated in certain locations by the laser, some material will generally remain within the bed in an unconsolidated state. This unconsolidated material is sometimes referred to as a “part cake.” In some embodiments, the part cake may be used to physically support features such as overhangs and thin walls during the formation process, allowing for SLS systems to avoid the use of temporary mechanical support structures, such as may be used in other additive manufacturing techniques such as stereolithography. In addition, this may further allow parts with more complicated geometries, such as moveable joints or other isolated features, to be printed with interlocking but unconnected components.

The above-described process of producing a fresh layer of powder and consolidating material using the laser repeats to form an object layer-by-layer until the entire object has been fabricated. Once the object has been fully fabricated, the object and the part cake may be cooled at a controlled rate so as to limit issues that may arise with fast cooling, such as warping or other distortion due to variable rate cooling. The object and part cake may be cooled while within the selective laser sintering apparatus, or removed from the apparatus after fabrication to continue cooling. Once fully cooled, the object can be separated from the part cake by a variety of methods. The unused material in the part cake may optionally be recycled for use in subsequent fabrication.

As discussed above, it is highly desirable in a system such as system 100 shown in FIG. 1 to wait for unconsolidated material that is delivered onto the fabrication bed to reach a consistent temperature before consolidating the material with the laser. This waiting period, which is performed for each layer of the object being fabricated, increases the time needed to fabricate the object.

The SLS device 100 may include one or more additional sensing, control, or environmental subsystems that cooperate with the laser 110, scanner system 115, powder delivery system 120, roller 125, fabrication powder bed 130, powder delivery pistons 121, fabrication platform 131, and object 140 being fabricated. For example, in some embodiments, the SLS device 100 may include a chamber heater, bed heater, gas-flow system, humidity sensor, chamber temperature sensor, powder-level sensor, recoater-position sensor, or build-platform position sensor. Data from such subsystems may be used to compensate the thermal or visual diagnostic results, for example by accounting for powder-bed preheat temperature, chamber temperature, powder layer thickness, powder condition, or environmental variation. However, the disclosure is not limited to these particular examples.

The diagnostic scans described herein may be performed on a production powder layer, on a sacrificial region of a powder layer, on an unused margin of the powder bed, on a calibration substrate, or on another suitable target region. In some embodiments, the scan parameters may be selected to induce a measurable thermal or visual response without undesirably consolidating powder in a region intended for part fabrication. For example, the scan may use a reduced power, shortened dwell time, increased scan speed, pulsed exposure, or a selected path outside the area corresponding to the object 140. In other embodiments, the diagnostic scan may deliberately form a visible but noncritical mark in a sacrificial region to improve detectability of optical-path defects.

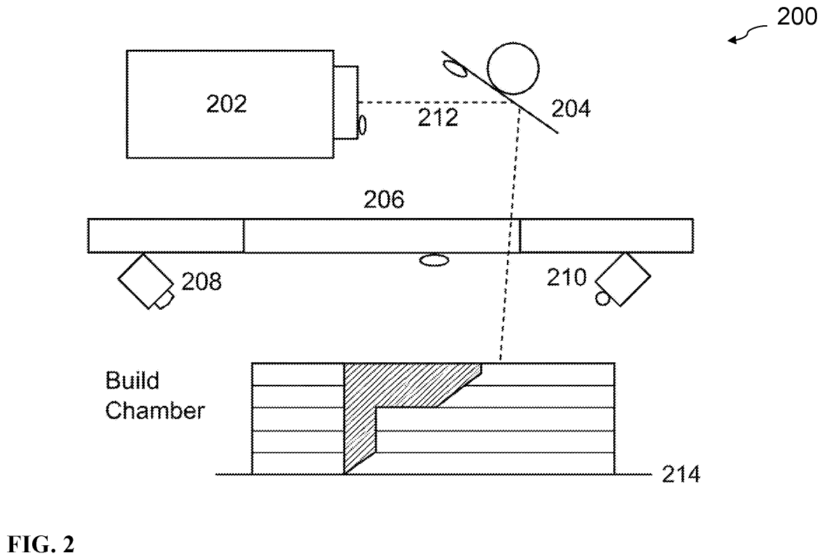

FIG. 2 illustrates a schematic diagram of a diagnostic and monitoring configuration for a selective laser sintering (SLS) system 200, including an optical path and sensor placement used to evaluate laser performance and provide real-time observation of the build process. The components shown may be integrated into an SLS system such as that depicted in FIG. 1.

A laser source 202 is mounted above the build chamber and configured to emit a laser beam 212 used for selectively sintering powdered material. The laser beam is directed toward a galvanometer mirror 204, which controls the position of the beam across the powder bed by reflecting it along variable angles. The beam is then directed downward through an optics window 206 into the build chamber.

The optics window 206 allows laser transmission while sealing the chamber against powder contamination. To monitor its condition, a camera 208 is positioned adjacent to the window, oriented toward the powder bed 214. The camera 208 may capture still images for diagnostic evaluation (e.g., after a scan pattern) or provide a continuous video feed for live monitoring of the build process.

The camera 208 is shown in FIG. 2 as positioned outside the optical path of the laser beam 212. In other embodiments, the camera 208 may be positioned coaxially with the laser beam 212, for example by way of a dichroic mirror, beam splitter, or other optical element that separates a thermal or visible imaging path from the laser path, such that the camera 208 images the powder bed 214 through substantially the same optical path traversed by the laser beam 212. In still other embodiments, the camera 208 may image the powder bed 214 through a separate camera window in the build chamber 218, or from a viewport external to the build chamber 218. A coaxial arrangement may be preferred where the diagnostic is intended to characterize the as-built optical path that the laser actually traverses, since artifacts that affect only the laser path (and not a separate viewing path) are then visible to the camera as well.

On the opposite side of the optics window is a temperature sensor 210, such as a thermal or infrared camera. The temperature sensor 210 is aimed at a central region of the powder bed 214, and is configured to detect a thermal response resulting from laser exposure. The temperature data can be used to infer laser power consistency and performance by comparing heating rates with expected values.

The powder bed 214 includes both unconsolidated powder and a sintered object 216, shown in darker shade in the figure to represent a part being fabricated. The build process occurs within a controlled build chamber 218, which may include additional environmental or thermal controls (not shown).

This sensor arrangement within SLS system 200 enables a dual-mode diagnostic approach. The combination of optical image analysis (via camera 208) and thermal response monitoring (via temperature sensor 210) allows the system to detect laser degradation, optics contamination, or process instability in real time or prior to commencing a print job.

In some embodiments, the SLS system 200 may further include a laser power monitor disposed upstream of the optics window 206, configured to sample a portion of the laser beam 212 before the beam reaches the optics window 206 or the powder bed 214. The laser power monitor may comprise, for example, a photodiode, a thermopile, a power meter, or a similar detector arranged to receive a fraction of the laser beam by way of a partially reflective mirror, a beam splitter, a back-surface tap, or leakage through a high-reflectance mirror. A measurement from the laser power monitor characterizes laser-source output substantially independent of optical losses occurring downstream of the monitor. Comparing a measurement from the laser power monitor with a heating-rate measurement obtained from the temperature sensor 210 may allow the system to distinguish between (i) a degradation of the laser source and (ii) a degradation of the optical path between the laser source and the powder bed. For example, a reduced heating rate accompanied by an unchanged upstream power reading may be attributed to optical-path losses, while a reduced heating rate accompanied by a correspondingly reduced upstream power reading may be attributed to laser-source degradation.

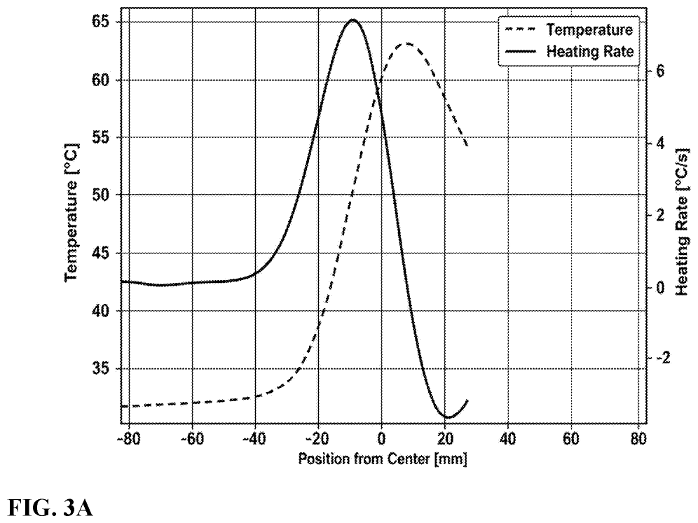

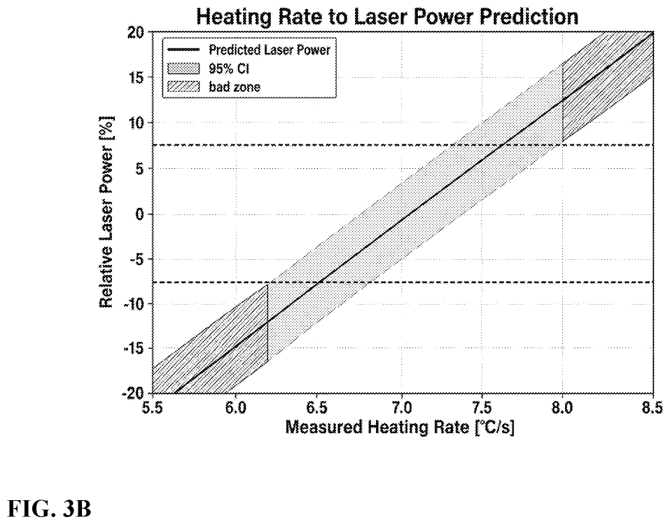

FIG. 3A illustrates thermal measurement data obtained during a diagnostic laser scan of the powder bed. The horizontal axis represents position along a scanned line, measured in millimeters from the center of the powder bed. The dashed line shows the measured temperature profile of the powder surface, while the solid line represents the heating rate, calculated as the first derivative of temperature with respect to time (i.e., dT/dt).

More specifically, in some embodiments the data illustrated in FIG. 3A corresponds to a single-pass scan in which the laser is translated once along a scan line crossing the powder bed, and the temperature sensor records a time-resolved temperature reading at each location imaged by the sensor. The heating rate plotted at a given position thus corresponds to the value of dT/dt observed at the pixel (or group of pixels) of the temperature sensor that images that location, evaluated at or near the time of the laser passing through that location. As used herein, unless otherwise indicated, the term “heating rate” refers to a peak positive slope of temperature versus time observed at a given location during the laser pass; however, alternative definitions-such as an initial slope of the temperature rise, an average slope over a specified time window, an area under the temperature-time curve, or another characteristic of the temperature-time response-may be substituted within the same diagnostic framework. The negative-going portion of the heating-rate curve shown in FIG. 3A corresponds to the cooling of the irradiated region after the laser beam has passed, and is treated separately below.

The temperature values are acquired using a temperature sensor (e.g., sensor 210 of FIG. 2) during a uniform laser scan performed at a known power level. From the temperature profile, a heating rate curve is derived, and a single representative data point-typically from the central region where laser focus and powder homogeneity are best-can be extracted for further diagnostic evaluation.

This heating rate serves as a system-level response metric. It can be compared against an expected reference value or used as an input to infer the actual delivered laser power, as described with reference to FIG. 3B.

In addition to the heating-rate metric described above, a cooling-rate metric may be derived from the temperature-time profile following passage of the laser beam, i.e., from the portion of the temperature-time curve in which dT/dt is negative as the previously irradiated region returns toward thermal equilibrium with its surroundings. The cooling rate is substantially dependent on the local thermal diffusivity and heat capacity of the powder bed, including factors such as powder moisture content, recycled-powder ratio, packing density, particle-size distribution, and bed preheat condition, and is substantially less dependent on the delivered laser power than is the heating rate. In some embodiments, the system may compare the heating-rate metric and the cooling-rate metric against respective reference values to distinguish between (i) anomalies attributable to laser power or optical-path conditions, which preferentially affect the heating-rate metric, and (ii) anomalies attributable to powder-bed condition, which preferentially affect the cooling-rate metric. Based on this comparison the system may direct a corrective action to the laser, the optical path, the powder-handling system, or a combination thereof.

FIG. 3B illustrates how a measured heating rate, such as that derived from FIG. 3A, may be used to infer the relative laser power delivered to the powder bed. The horizontal axis corresponds to the measured heating rate (in °C/s), and the vertical axis represents the predicted laser power, expressed as a percentage deviation from a nominal or calibrated baseline.

The solid black line represents a predictive model that maps heating rate to relative laser power. This relationship may be established during system calibration or machine learning-based regression using training data from multiple diagnostic scans. The gray region surrounding the line represents a 95% confidence interval, accounting for measurement and modeling uncertainty.

Red-shaded areas in the graph represent “bad zones”-regions where the predicted laser power deviates beyond acceptable operational thresholds (e.g., ±10%). If a measured heating rate falls within these red zones, it may indicate a fault such as laser power drift, optics degradation, or beam misalignment.

During routine machine diagnostics, a heating rate is measured, and the corresponding inferred laser power is computed using the predictive model. This inferred value can then be compared to the commanded or expected power setting to determine whether corrective action is needed, such as recalibration, cleaning of optical components, or preventive maintenance.

In some embodiments, the temperature sensor 210 of FIG. 2 may include an infrared camera, a pyrometer, a thermopile sensor, a thermal imaging array, a photodiode-based thermal detector, a contact or near-contact temperature sensor associated with the powder bed, or a combination of sensors. The temperature sensor 210 may measure an absolute powder-bed surface temperature, a relative temperature increase, a temperature-time profile, a cooling profile after laser exposure, or a spatial thermal map. A heating-rate metric may be derived from one or more of an initial slope of temperature increase, an average slope over a predetermined time window, a maximum slope, an area under a temperature-time curve, a peak temperature rise, or a thermal decay characteristic following laser shutoff.

FIGS. 3A and 3B together represent a two-step diagnostic process: (1) measuring temperature and computing heating rate, and (2) inferring laser power from heating rate and detecting deviations.

In some embodiments, the relationship between laser power and heating rate described with reference to FIG. 3B may be represented by a linear function, a nonlinear function, a polynomial function, a spline, a lookup table, an interpolation table, a regression model, a machine-learning model, or another suitable mapping. The relationship may be generated for a particular powder material, particle-size distribution, powder age, recycled-powder ratio, layer thickness, bed preheat temperature, scan speed, spot size, chamber temperature, or humidity condition. Multiple relationships may be stored and selectively applied depending on a current build recipe or sensed operating condition.

The comparison of measured heating rate to expected heating rate may be performed using an absolute threshold, a percentage threshold, a confidence interval, a statistical control limit, a moving average, a trend score, a region-specific tolerance, a material-specific tolerance, or a multi-factor diagnostic score. In some embodiments, the system may generate a pass/fail result, a severity level, a confidence value, or a recommended action. Example severity levels may include normal operation, warning, service recommended, calibration required, or build inhibited. The particular threshold values may be selected based on desired build quality, machine configuration, material sensitivity, or historical machine behavior.

The spatial profiles illustrated in FIG. 3A may be used to detect field-dependent variations in delivered energy across the powder bed. For example, a center-to-edge difference in heating rate may indicate lens transmission variation, scan-field calibration error, defocus at peripheral scan angles, or partial contamination of an optical window. A left-right or front-back asymmetry may indicate scanner misalignment, beam clipping, mirror contamination, or nonuniform powder spreading. In some embodiments, the system may compare a measured heating-rate map to an expected spatial map and identify a location, region, or optical-path portion associated with an observed deviation.

Further, in some embodiments, a spatial heating-rate map measured as described above may be used to derive a spatial compensation map for use during fabrication. The spatial compensation map may store, for each of a plurality of regions of the powder bed, a commanded-power scale factor selected to compensate for a measured reduction or increase in delivered energy at that region relative to a reference. During fabrication, the system may apply the spatial compensation map by modulating the commanded laser power, the commanded scan speed, the commanded hatch spacing, or another exposure parameter as a function of scan position, such that delivered energy at the powder bed is substantially uniform across the bed despite field-dependent optical losses, transmission variation, defocus, or partial contamination of an optical element. The spatial compensation map may be updated periodically, after a detected change in heating-rate map, after a maintenance event affecting the optical path, or in response to a user instruction.

The diagnostic laser scan may have any suitable pattern for producing thermal or visual information. In some embodiments, the scan pattern may include a raster pattern, serpentine pattern, spiral pattern, radial pattern, concentric ring pattern, checkerboard pattern, repeated line scan, spot exposure, pulsed exposure at multiple positions, or a scan path expanding outward from a central region toward peripheral edges of the powder bed. A scan path may be selected to sample different scanner angles, different lens regions, different powder-bed regions, or different portions of the optical path. This configuration allows the diagnostic to evaluate not only total delivered power but also spatial uniformity of delivered energy.

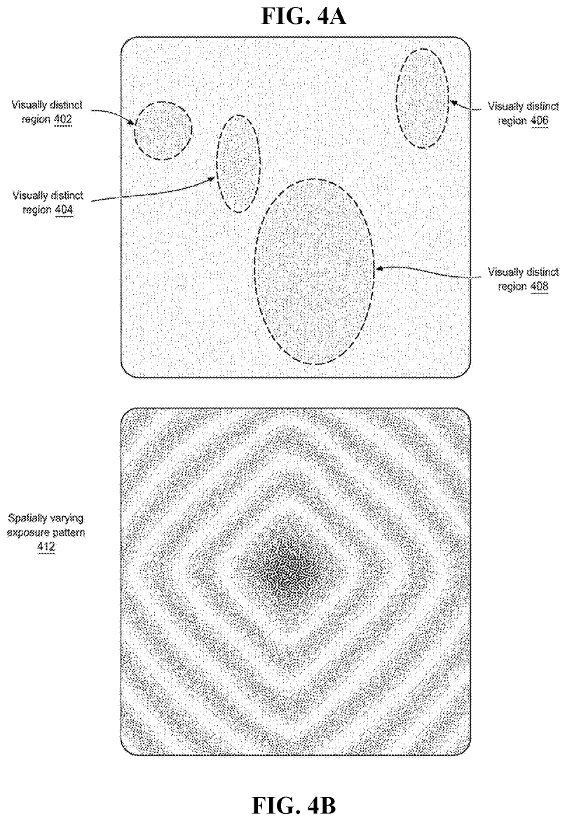

FIGS. 4A-4B present example images of a powder bed taken by an onboard camera (e.g., camera 208 in FIG. 2) following a diagnostic laser scan. These images are used to evaluate the optical integrity of components in the laser path, including the galvo mirror, protective window, and any intervening optics.

In other embodiments, the camera 208 may capture one or more images during the diagnostic laser scan, rather than (or in addition to) capturing an image after completion of the scan. In such embodiments, thermal or near-infrared emission from the locally heated region of the powder bed may itself produce a visible signature on the captured image, such that the trajectory of the laser beam can be reconstructed directly from the captured image data. A spectral filter, a polarization filter, a stop-down aperture, a high-speed shutter, or another optical filter may be coupled to the camera 208 to enhance contrast between laser-induced emission and ambient illumination of the powder bed. A reconstructed laser trajectory may be compared with a commanded scan trajectory to identify a scanner calibration error, a beam-positioning error, a beam-clipping condition, a missing scan region, or another optical-path or scanner condition.

In one example image of FIG. 4A, localized visually distinct regions 402, 404, 406, and 408 are present on the powder bed image. Such regions may appear as localized bright regions, localized dark regions, spots, shadows, streaks, smudged regions, or other contrast variations relative to surrounding portions of the powder bed image. In some embodiments, the system may identify the presence, absence, size, shape, intensity, contrast, spatial distribution, or temporal persistence of such visually distinct regions.

In one example image of FIG. 4A, certain localized visually distinct regions are emphasized with corresponding annotations that have been applied either automatically by an image-analysis pipeline or manually by a user, so as to indicate regions of the powder bed image that the pipeline (or user) has identified as candidates for further inspection. The annotations may comprise contours, bounding boxes, colored highlights, numerical labels, severity classifications, or another marker. The annotations need not be limited to the form depicted in FIG. 4A; the closed curves shown in FIG. 4A are illustrative only. In some embodiments, the annotations may be stored together with the captured image in a maintenance log, presented to a user via a display, or transmitted to a remote diagnostic service.

In another example image of FIG. 4B, a spatially varying exposure pattern 412 is visible across the powder bed, such as a wavy, ring-like, concentric, banded, or interference-like pattern. Such a pattern may be indicative of beam-profile nonuniformity, field-dependent optical distortion, optical interference, scanner calibration error, lens or window contamination, beam clipping, defocus, or another optical-path condition. In some embodiments, the particular cause of the pattern need not be uniquely determined in order for the system to identify that further inspection, cleaning, recalibration, or maintenance may be warranted.

In some embodiments, the spatial frequency, symmetry, orientation, or radial distribution of a spatially varying exposure pattern 412 such as that shown in FIG. 4B may be analyzed and associated with a particular class of optical-path condition. For example, a substantially radially symmetric pattern centered on the optical axis may be associated with a defocus condition, a window-tilt condition, or a beam-profile distortion of the laser source. A pattern that is symmetric but off-axis with respect to the optical axis may be associated with mirror contamination or scanner offset. A pattern that exhibits one or more high-spatial-frequency components, such as ring or fringe spacings narrower than a characteristic dimension of the beam, may be associated with thin-film interference, coating delamination, or multilayer contamination of an optical window. These associations are exemplary; a particular spatial pattern need not be uniquely attributable to a single root cause in order for the system to flag the pattern as warranting further inspection, cleaning, recalibration, or maintenance.

By analyzing such images-either manually or using image processing algorithms-the system can detect and localize optical path issues before initiating a print.

This diagnostic scan may be run periodically or as part of a pre-print check to prevent quality degradation due to invisible contamination in the optics train.

When paired with thermal diagnostics (e.g., FIGS. 3A and 3B), this visual inspection provides a complementary diagnostic channel, enabling comprehensive verification of both laser power and beam quality.

In various embodiments, the systems and methods described herein enable a selective laser sintering (SLS) device to self-diagnose the performance of its laser system and optical path before or during a print job. These diagnostic procedures may include thermal response analysis and image-based evaluation of a powder bed subjected to controlled laser scanning patterns.

### I. Establishing a Laser Power-Heating Rate Reference

In one aspect, a method is provided for determining a performance reference of an SLS device based on the thermal response of the powder bed to laser irradiation. The method comprises directing a laser beam onto at least a portion of the powder bed at a first laser power level, and monitoring the surface temperature of the irradiated powder over time using a temperature sensor, such as an infrared camera or pyrometer. From the temporal temperature profile, the system calculates a first heating rate, corresponding to the rate of temperature increase (i.e., dT/dt) in response to the first laser power setting.

Subsequently, the system performs one or more additional laser scans on the powder bed at different laser power levels and records corresponding temperature profiles. For each scan, a heating rate is calculated. The system uses the collected data to determine a functional relationship between laser power and heating rate. This relationship may be linear or nonlinear, and may be expressed in analytical, tabulated, or machine-learned form. In some implementations, only a single data point (e.g., from the center of the scan pattern) is used to characterize the heating rate for a given power setting.

The resulting relationship serves as a calibration reference, indicating how the powder bed is expected to respond thermally under ideal laser conditions. This reference can later be used to infer laser output performance based on measured thermal data.

In certain embodiments, the laser scan comprises a translation of a laser spot along a defined trajectory over the powder bed. In other embodiments, the scan comprises pulsing the laser at a fixed location. Either modality may be used to induce a measurable heating response.

### II. Diagnosing Laser Output Via Heating Rate Comparison

In another aspect, a method is provided for diagnosing performance of an SLS device by comparing an inferred laser power to a commanded power value. The method comprises directing a laser beam onto at least a portion of the powder bed at a known input laser power setting, and recording a temperature-over-time profile of the irradiated region using the temperature sensor. The system then calculates a heating rate from the measured data

Using the previously determined reference relationship between heating rate and laser power, the system calculates an inferred laser power setting—i.e., the power level that would have been expected to generate the measured heating rate. The inferred power is then compared to the commanded power setting. A significant deviation (e.g., exceeding a threshold of ±5% or ±10%) may indicate laser degradation, power delivery inconsistencies, beam misalignment, or optical losses due to contamination.

In some embodiments, in response to determining that the inferred laser power deviates from the commanded laser power by a measured fraction X, the system may automatically adjust a commanded laser power for a subsequent scan or for a subsequent build by a compensation factor selected to restore an expected delivered power at the powder bed. For example, where the inferred power is reduced by a fraction X relative to the commanded power, the system may scale a subsequent commanded power by a factor of approximately 1/(1−X), or by another compensation factor derived from the measured deviation, up to a maximum permitted compensation. The maximum permitted compensation may be selected based on a hardware capability of the laser, a thermal limit of an optical component, a process-quality threshold, or a safety threshold. Where the indicated compensation exceeds the maximum permitted compensation, the system may instead generate an alert, schedule maintenance, or inhibit further builds. In this manner, the diagnostic measurement may be used not only to detect a degradation but also to mitigate its effect on print quality between scheduled maintenance events.

This diagnostic process may be performed prior to initiating a print job, or during inter-layer pauses, enabling early detection of laser instability and avoidance of failed builds.

In some embodiments, the system may store diagnostic measurements-including heating-rate measurements, cooling-rate measurements, inferred-power values, deviation values, spatial heating-rate maps, and image-based diagnostic results-as a time series, and may apply a trend analysis to the time series to detect a progressive change occurring across multiple diagnostic measurements. A progressive change may include, for example, a gradual reduction in heating rate over successive scans, a gradual increase in spatial nonuniformity, a gradual increase in the size or number of identified visually distinct regions, or a gradual change in cooling-rate metric. In some embodiments, the trend analysis may include a linear or nonlinear regression, an exponentially weighted moving average, a statistical process control chart, a Bayesian change-point detection, or a machine-learning model. The system may generate a predicted time at which a monitored metric is expected to cross a diagnostic threshold, may schedule a maintenance event before the predicted time, may transmit a service notification to a remote system, or may otherwise act on the trend before the metric reaches an absolute diagnostic threshold.

### III. Diagnosing Optics Quality Via Image-Based Analysis

In a further aspect, a method is provided for evaluating the optical path integrity of an SLS device using image analysis. The method includes performing a diagnostic laser scan over at least a portion of the powder bed, where the scan pattern may be configured to enhance detection of optical defects. For example, the pattern may originate at a central region of the powder bed and expand radially outward toward the periphery, ensuring all beam angles and positions are sampled.

Following the scan, an image of the powder bed is captured using an onboard camera system. The image is analyzed to identify visually distinct features, such as bright spots, shadows, streaks, or asymmetries in laser exposure. The presence, size, shape, or distribution of such features may be indicative of contamination or damage to the optical elements, including the scanning mirror, lens, or protective window.

In some embodiments, image analysis is performed automatically using computer vision algorithms. In other embodiments, the image may be presented to a user for manual review. Regions of interest may be highlighted or classified based on contrast deviation or known defect signatures.

This visual diagnostic complements the thermal-based diagnostics described above, providing additional visibility into issues that affect beam shape, focus, and transmission even if laser power output remains nominal. The image-based check can detect, for example, particulate buildup on the optics window, smudges or scratches on galvo mirrors, or misalignment artifacts.

Image analysis performed on the images of FIGS. 4A-4B may include thresholding, contrast analysis, background subtraction, edge detection, blob detection, texture analysis, template matching, pattern recognition, feature extraction, heat-map generation, or classification using a trained model. In some embodiments, a reference image of a clean optical path may be compared with a later diagnostic image to determine a difference image. Regions of interest may be highlighted for a user, stored in a maintenance log, or associated with a suspected defect type. However, the disclosure is not limited to any particular image-processing technique.

The image-based diagnostic may classify or otherwise indicate possible optical-path conditions, including powder or dust on a protective window, a smudge on an optical surface, a scratch, a damaged lens, reduced optical transmission, beam clipping, defocus, mirror contamination, scanner misalignment, distorted spot shape, nonuniform beam profile, or a field-dependent illumination artifact. In some embodiments, localized spots may be associated with localized contamination or damage, elongated streaks may be associated with scanning artifacts or scratches, and broad wavy or ring-like patterns may be associated with field nonuniformity, interference effects, or beam-profile distortion. These examples are illustrative and are not limiting.

In some embodiments, the thermal diagnostic information and the image-based diagnostic information may be combined to provide a more robust diagnosis than either modality alone. For example, a reduced heating rate combined with visually distinct image regions may indicate optical contamination that reduces delivered power. A normal heating rate combined with a distorted image pattern may indicate that total power is acceptable but beam uniformity or focus is degraded. A reduced heating rate with no corresponding image anomaly may indicate laser-source degradation or power-supply drift. Based on the combined result, the system may generate an alert, recommend cleaning of an optical window, initiate recalibration, pause or prevent a build, adjust a process parameter, perform a confirmatory diagnostic scan, transmit diagnostic information to a remote service system, or store a maintenance record,

In some embodiments, the diagnostic functionality described with reference to FIGS. 1, 2, 3A, 3B, 4A and 4B may be implemented by a controller of the SLS device, by one or more processors associated with the SLS device, by a locally connected maintenance computer, by a remote diagnostic service, or by a combination thereof. The controller may execute instructions stored in a non-transitory computer-readable memory to command laser scans, receive temperature data, receive image data, generate diagnostic metrics, compare the diagnostic metrics with stored reference data, and output maintenance or calibration information. The reference data may include factory calibration data, installation calibration data, material-specific calibration data, chamber-condition-specific calibration data, or historical diagnostic data collected from the same SLS device.

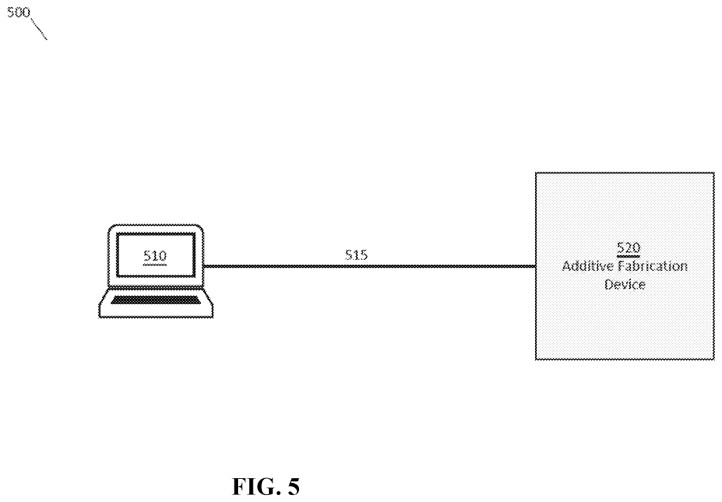

FIG. 5 is a block diagram of a system suitable for practicing aspects of the disclosure, according to some embodiments. System 500 illustrates a system suitable for generating instructions to perform SLS by a device (e.g., device 100) comprising a powder fusion apparatus, and subsequent operation of the additive fabrication device to fabricate an object. For instance, instructions to fabricate the object using an additive fabrication system may comprise instructions to operate one or more powder deposition mechanisms, lasers, heaters, etc. In some cases, the instructions may also, when executed by the SLS device 100, cause the additive fabrication device to operate a temperature sensor in concert with the one or more powder deposition mechanisms, lasers, heaters, etc.

According to some embodiments, computing system 510 may execute software that generates two-dimensional layers that may each comprise sections of the object. Instructions may then be generated from this layer data to be provided to an additive fabrication device 520 (e.g., implemented as SLS device 100), that, when executed by the device, fabricates the layers and thereby fabricates the object. Such instructions may be communicated via link 515, which may comprise any suitable wired and/or wireless communications connection. In some embodiments, a single housing holds the computing system 510 and additive fabrication device 520 such that the link 515 is an internal link connecting two modules within the housing of system 500.

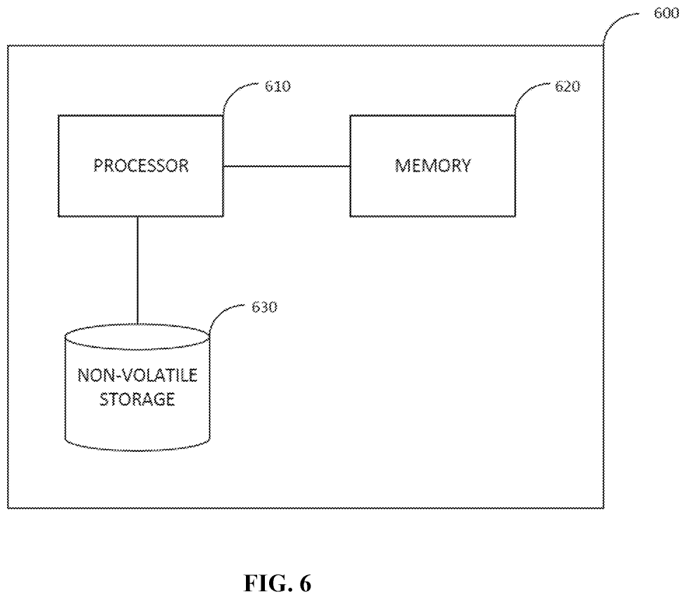

An illustrative implementation of a computer system 600 that may be used to control an additive fabrication system (e.g., device 100) to perform any of the techniques described above is shown in FIG. 6. The computer system 600 may include one or more processors 610 and one or more non-transitory computer-readable storage media (e.g., memory 620 and one or more non-volatile storage media 630). The one or more processors 610 may control writing data to and reading data from the memory 620 and the one or more non-volatile storage media 630 in any suitable manner, as the aspects of the disclosure described herein are not limited in this respect. To perform functionality and/or techniques described herein, the one or more processors 610 may execute one or more instructions stored in one or more computer-readable storage media (e.g., the memory 620, storage media, etc.), which may serve as non-transitory computer-readable storage media storing instructions for execution by the one or more processors 610.

In connection with techniques described herein, code used to, for example, generate instructions to fabricate a part according to a digital description of an object, including instructions to operate a powder deposition mechanism, laser, heater, etc. may be stored on one or more computer-readable storage media of computer system 600. The one or more processors 610 may execute any such code to perform any of the above-described techniques as described herein. Any other software, programs or instructions described herein may also be stored and executed by computer system 600. It will be appreciated that computer code may be applied to any aspects of methods and techniques described herein.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as described above.

The terms “program,” “software,” and/or “application” are used herein in a generic sense to refer to any type of computer code or set of computer-executable instructions that can be employed to program a computer or other processor to implement various aspects of embodiments as described above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Having thus described several aspects of at least one embodiment of this disclosure, it is to be appreciated that various alterations, modifications, and improvements will readily occur to those skilled in the art.

Aspects of the above-described embodiments of the technology described herein can be implemented in any of numerous ways. For example, aspects of the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for establishing a performance reference for a selective laser sintering (SLS) device, the method comprising:
performing a first laser scan over at least a portion of a powder bed at a first laser power setting;
measuring, using a temperature sensor, a first heating rate of the powder bed in response to the first laser scan;
performing a second laser scan over at least a portion of the powder bed at a second laser power setting different from the first laser power setting;
measuring, using the temperature sensor, a second heating rate of the powder bed in response to the second laser scan; and
determining, based at least on the first heating rate and the second heating rate, a relationship between laser power and heating rate, the relationship usable as the performance reference for the SLS device.

2. The method of claim 1, wherein at least one of the first laser scan and the second laser scan comprises translating a laser spot along a defined trajectory over the powder bed.

3. The method of claim 1, wherein at least one of the first laser scan and the second laser scan comprises pulsing a laser at a fixed location on the powder bed.

4. The method of claim 1, wherein the first heating rate and the second heating rate are each determined as a peak positive slope of temperature versus time observed at a location traversed by the corresponding laser scan.

5. The method of claim 1, wherein the relationship between laser power and heating rate comprises one or more of a linear function, a nonlinear function, a polynomial function, a spline, a lookup table, a regression model, and a machine-learning model.

6. A method of operating a selective laser sintering (SLS) device, the method comprising:
performing a diagnostic laser scan over at least a portion of a powder bed at a commanded laser power setting;
measuring, using a temperature sensor, a heating rate of the powder bed in response to the diagnostic laser scan;
determining an inferred laser power setting based on the measured heating rate and a stored relationship between laser power and heating rate;
comparing the inferred laser power setting with the commanded laser power setting to obtain a deviation; and
responsive to the deviation exceeding a threshold, applying a corrective action to the SLS device.

7. The method of claim 6, wherein the corrective action comprises adjusting a subsequent commanded laser power setting by a compensation factor selected to restore an expected delivered power at the powder bed.

8. The method of claim 7, wherein the compensation factor is approximately 1/(1−X), where X is a fractional amount by which the inferred laser power setting is reduced relative to the commanded laser power setting, the compensation factor being limited by a maximum permitted compensation.

9. The method of claim 6, further comprising:
measuring, using the temperature sensor, a cooling rate of the powder bed following passage of a laser beam during the diagnostic laser scan; and
comparing the measured cooling rate with a cooling-rate reference to identify a powder-bed condition anomaly distinct from a laser-power or optical-path anomaly.

10. The method of claim 6, wherein the diagnostic laser scan samples a plurality of positions on the powder bed, the method further comprising:
determining a spatial heating-rate map from a plurality of heating-rate measurements;
deriving a spatial compensation map storing a position-dependent commanded-power scale factor based on the spatial heating-rate map; and
during a subsequent build by the SLS device, modulating a commanded laser power as a function of scan position in accordance with the spatial compensation map.

11. The method of claim 6, wherein the diagnostic laser scan is performed during fabrication of an object by the SLS device, during an inter-layer pause, in an unused margin of the powder bed of the SLS device.

12. The method of claim 6, further comprising:
obtaining a measurement from a laser power monitor disposed upstream of an optics window of the SLS device; and
comparing the measurement from the laser power monitor with the measured heating rate to distinguish between (i) a degradation of a laser source of the SLS device and (ii) a degradation of an optical path between the laser source and the powder bed.

13. The method of claim 6, further comprising:
storing a plurality of heating-rate measurements obtained over time as a time series;
applying a trend analysis to the time series to identify a progressive change in heating rate; and
generating, based on the trend analysis, a predicted time at which a monitored metric is expected to cross the threshold.

14. The method of claim 6, further comprising:
capturing, using a camera, an image of at least a portion of the powder bed; and
generating a diagnostic result for the SLS device based on a combination of the measured heating rate and an analysis of the captured image.

15. The method of claim 6, wherein the threshold corresponds to a deviation of at least 5% between the inferred laser power setting and the commanded laser power setting.

16. A method of evaluating an optical path of a selective laser sintering (SLS) device, the method comprising:
performing a diagnostic laser scan over at least a portion of a powder bed of the SLS device;
capturing, using a camera, an image of the at least a portion of the powder bed; and
analyzing the captured image to identify a visually distinct region indicative of an optical-path condition of the SLS device.

17. The method of claim 16, wherein the diagnostic laser scan originates at a central region of the powder bed and expands outward toward a peripheral region of the powder bed.

18. The method of claim 16, wherein the camera images the powder bed coaxially with a laser beam of the SLS device via a dichroic mirror or beam splitter that separates a camera path from a laser path.

19. The method of claim 16, wherein the captured image is captured during the diagnostic laser scan, and a thermal or near-infrared emission from a locally heated region of the powder bed produces a visible signature on the captured image from which a trajectory of a laser beam is reconstructed.

20. The method of claim 16, wherein analyzing the captured image comprises analyzing one or more of a spatial frequency, a symmetry, an orientation, and a radial distribution of a spatially varying exposure pattern in the captured image, and associating the spatially varying exposure pattern with the optical-path condition based on the analysis.
